(19) United States
(12) Patent Application Publication
(10) Pub. No.: US 2026/0088495 A1
(43) Pub. Date: Mar. 26, 2026

(54) GEARBOX FOR A BASE STATION ANTENNA, ANTENNA AND BASE STATION

(71) Applicant: TELEFONAKTIEBOLAGET LM ERICSSON (PUBL), Stockholm (SE)

(72) Inventor: Robert Schiesser, Rosenheim (DE)

(21) Appl. No.: 19/111,390

(22) PCT Filed: Sep. 14, 2022
(86) PCT No.: PCT/EP2022/075561

§ 371 Date: Mar. 13, 2025

(51) Int. Cl. H01Q 3/32; F16H 25/18; F16H 25/20; H01Q 1/24

(52) U.S. Cl. CPC H01Q 3/32; F16H 25/186; F16H 25/20; H01Q 1/246

(57) ABSTRACT

A gearbox for an antenna, an antenna including the gearbox as well as a mobile communication base station including the antenna. The gearbox comprises at least two phase shift adjustment spindles that can be coupled to a respective phase shifter of the antenna and driven for electrically adjusting a radiation beam direction of the antenna. A rotary driving actuator of the gearbox is adapted to rotate a coupling element. A function selector actuator includes a movable function selector element that is fixed to the coupling element and to a coupling mechanism of the gearbox, wherein the function selector element is movable from a first position to a second position thereby actuating the coupling element and the coupling mechanism to either adjust a phase shifter or to select a phase shifter to be adjusted.

### FIELD OF THE INVENTION

The present invention relates to a gearbox for an antenna, in particular a base station antenna, an antenna including said gearbox as well as a mobile communication base station including said antenna.

### BACKGROUND

Antennas and in particular base station antennas for mobile communication networks need to be optimized to achieve an ideal coverage of a communication cell.

Typically for achieving an ideal coverage, a radiation direction of a base station antenna of a base station of a particular network communication cell is adjusted, enabling radiation beam(s) of said antenna to cover a predefined area. Particularly, the radiation direction of the radiation beam needs to be adjusted according geographical circumstances, the distribution of users, being located in the cell and/or other factors.

Usually, adjusting the radiation direction includes adapting an (down-)tilt angle θ (vertical direction) of a radiation beam and/or an azimuth angle α (horizontal direction) of the radiation beam.

Generally, the adjustment of the tilt and/or azimuth angles is achieved by physically orienting the entire antenna, e.g. by using a mechanical adjustment device (such as a mechanical electrical tilt (MET) device) and/or by adjusting a (or multiple) phase shifters of the antenna. A phase shifter adapts the signal phase of single antenna elements of the antenna, so as to achieve a change of the beam radiation direction. The phase shifter(s) may be controlled by a remote controller, as e.g. in a remote electrical tilting, RET, device.

Further, it is a recent trend in mobile communication to use multiband antennas, i.e. antennas that integrate multiple frequency bands. For adjusting the beam radiation direction of those multiband antennas mechanical tilting is mostly unsuited, as a mechanical tilting device cannot meet the requirements of different frequency dependent tilt angle functions. For remote electronic tilting and/or azimuth angle control, multiple phase shifters are required, wherein it is desirable to control each phase shifter individually, to obtain maximum flexibility in tilt and azimuth angle control.

Antennas having multiple phase shifter(s) and/or a phase shifter assembly to generate a phase shift between different antenna elements of an antenna are widely known. It is further known to use phase shifters with a movable dielectric material to achieve the desired phase shift. The dielectric material may be moved rotationally or translationally, depending on the type of phase shifter. For adjusting the phase shift, the phase shifters are coupled to one or more actuators, such as stepper motors. Further, gearboxes or other gearing devices may be used.

For example, CN 210 006 921 U1 suggests a multi-frequency electrically-tunable antenna. For achieving an antenna adjustment, a plurality of phase shifting mechanisms is actuated using a gearing device.

Further, CN212318756 U1 suggests a shiftable transmission mechanism for a base station antenna. The shiftable transmission mechanism includes a plurality of axially drivable members each mounted on a respective one of a plurality of transmission bars arranged in parallel and configured to be connected to a respective one of a plurality of phase shifters in a base station antenna.

Such actuators and/or gearing devices are often times bulky and even increase in size with the number of phase shifters to be actuated. Further, the position of the phase shifters is oftentimes determined by the gearing device. Thus, exchanging the antenna or antenna elements and/or respective phase shifters is limited.

Further, particularly gearings suffer from drifting. I.e. after having adjusted the phase shifter, the rotational or translational position of the gearing might unintentionally change, resulting in an undesired variation of the phase shift and accordingly to a misalignment of the beam radiation direction.

It is therefore an object of the present invention to provide a gearing that overcomes the aforementioned drawbacks, at least partially.

### SUMMARY

The object is achieved by a gearbox according to claim 1, by an antenna according to claim 16 and by a base station according to claim 20. Further aspects of the present disclosure are given in the dependent claims as well as the following description.

The object is in particular achieved by a gearbox for an antenna, such as a base station antenna. The antenna including at least two phase shifters for adjusting a radiation beam direction (azimuth angle α and/or tilt angle θ) of the antenna. Particularly, the antenna may include at least three phase shifters, at least five phase shifters or at least seven phase shifters.

The gearbox comprises at least two phase shift adjustment spindles that can be coupled to a respective phase shifter of the antenna and driven for electrically adjusting a radiation beam direction of the antenna. Thus, the number of phase shift adjustment spindles may correspond to the number of phase shifters of the respective antenna. Hence, the gearbox comprises may comprise at least three phase shift adjustment spindles, at least five phase shift adjustment spindles or at least seven phase shift adjustment spindles.

The phase shift adjustment spindles may be coupled directly or indirectly to a respective phase shifter. In case of an indirect coupling, there may be further gearing stages in the transmission path, such as a reduction gearing or a linear gearing. A reduction gearing may provide for an increased accuracy in phase shift control and a linear gearing may allow actuating a linear actuated phase shifter.

Further, the gearbox comprises a rotary driving actuator, and a function selector actuator. The rotary driving actuator may be any kind of rotary drive, particularly an electric motor (such as a stepper motor, a brushless DC-motor, a brushed DC motor, . . . ), a hydraulic motor, a pneumatic motor and/or the like. The rotary driving actuator is adapted to rotate a coupling element of the gearbox. As will be described in greater detail below, rotation of the coupling element may be used to select a select a phase shift adjustment spindle to be driven or to drive a selected phase shift adjustment spindle, depending on the function, selected by the function selector actuator.

The function selector actuator includes a moveable function selector element that is fixed to the coupling element and to a coupling mechanism of the gearbox. The function selector element is movable from a first position to a second position thereby actuating the coupling element and the coupling mechanism.

The function selector actuator may be an angular actuator or a linear actuator. In case of a linear actuator, the function selector element is linearly moved from the first position to a second position. The linear actuator may include a mechanical linear actuator, such as a cam actuator, a rack and pinion actuator, a chain drive, a belt drive, a screw based drive (including e.g. a threaded spindle, a ball screw or a roller screw), or the like. Further, the linear actuator may be a magnetic, hydraulic, pneumatic and/or electromechanical actuator. Further, the function selector actuator may be a linear gearing only, that can be coupled to a respective drive (e.g. an electric motor, particularly a stepper motor, a brushless DC-motor, a brushed DC motor, or the like) to move the function selector element.

When the function selector element is in its first position, the coupling element is coupled with a phase shift spindle selector gearing. Said phase shift spindle selector gearing translates a rotational movement of the rotary driving actuator (which rotates the coupling element) into a linear movement of a phase shift spindle selector element in order to select a phase shift adjustment spindle to be driven. The phase shift spindle selector element supports a phase shift adjustment spindle drive gear, that is adapted to drive the selected phase shift adjustment spindle. Hence, the rotary driving actuator can drive the phase shift adjustment spindles individually, allowing to adjust the respective phase shifters individually, as well.

In the second position, the coupling element is coupled with a phase shift adjustment gearing (and uncoupled from the phase shift spindle selector gearing). The phase shift adjustment gearing couples the rotary driving actuator with the phase shift adjustment spindle drive gear in order to drive the selected phase shift adjustment spindle.

Further, when the function selector element is in its first position, the phase shift adjustment spindle drive gear is uncoupled from the selected phase shift adjustment spindle via the coupling mechanism, and when the function selector element is in its second position the phase shift adjustment spindle drive gear is coupled with the selected phase shift adjustment spindle via the coupling mechanism.

The above gearbox allows to adjust different phase shifters individually, by using to actuators (rotary driving actuator and a function selector actuator), only. This allows for a compact and cost efficient design. Further, by coupling/uncoupling the phase shift adjustment spindle drive gear when being not in use, undesired drift of the gearing can be prevented, allowing for a more accurate and permanent phase shift adjustment. Even further, as the phase shift spindle selector element is moved linearly to select a phase shift adjustment spindle to be driven, the position of the phase shift adjustment spindle has not to be fixed in advance and can be changed, e.g. in course of an adaption of the antenna. In case a position of the phase shift adjustment spindle changes, the phase shift spindle selector element can simply be moved to the respective new position and no further amendment of the gearbox is required.

The function selector actuator may include a function selector motor and a function selector spindle, particularly a threaded spindle, a ball screw or a roller screw. The function selector motor may be a stepper motor, a brushless DC-motor, a brushed DC motor, or the like. According to this aspect, the function selector element engages with the function selector spindle, so as to translate a rotational movement of the function selector motor into a linear movement of the function selector element, at least from the first to the second position.

The function selector element may further include a receiving portion for receiving the coupling element so as to allow the coupling element being rotated relative to the function selector element, while a linear movement of the function selector element causes a linear movement of the coupling element. Thus, the coupling element is supported and at the same time moveable to be either coupled with the phase shift spindle selector gearing or the phase shift adjustment gearing. The receiving portion may include a bearing seat and a bearing (e.g. a plain bearing or a rolling bearing) for rotatingly support the coupling element.

Further the phase shift spindle selector gearing may include a selector spindle, particularly a screwed spindle, such as a threaded spindle, a ball screw or a roller screw, and/or the like. The selector spindle has a selector spindle coupling that is coupled with a corresponding selector spindle coupling of the coupling element, when the function selector element is in its first position. According to this aspect, the phase shift spindle selector element engages with the selector spindle, so as to translate a rotational movement of the coupling element (and accordingly of the selector spindle that is driven by the coupling element) provided by the rotary driving actuator into a linear movement of the phase shift spindle selector element. Hence, the phase shift spindle selector element can be linearly moved to select a phase shift adjustment spindle to be driven.

The selector spindle may be supported by at least one bearing support. The bearing support may include at least one bearing seat and a bearing (e.g. a plain bearing or a rolling bearing) for rotatingly support the selector spindle. Further, the bearing support may further have a sliding member.

The coupling mechanism may include at least on actuating rod. The actuating rod is fixed to the function selector element either directly or indirectly. In case of an indirect fixation, further elements are provided between the actuating rod and the function selector element. However, in either case, a movement of the function selector element will actuate the actuating rod. The actuating rod includes at least one corresponding sliding member.

The sliding member of the bearing support is in engagement with the corresponding sliding member of the actuating rod. The corresponding sliding member is formed so that a movement of the function selector element from the first position to the second position moves the at least one bearing support causing the phase shift adjustment spindle drive gear to couple with the selected phase shift adjustment spindle. And a movement of the function selector element from the second to the first position moves the at least one bearing support causing the phase shift adjustment spindle drive gear to uncouple from the selected phase shift adjustment spindle. Hence, the phase shift adjustment spindle drive gear can be coupled with a selected phase shift adjustment spindle to adjust the phase shift and can be uncoupled, if the phase shift needs no further adjustment. Thus, undesired drift of the gearing can be prevented.

Particularly, the bearing support supporting the selector spindle may be lifted and/or lowered by the movement of the function selector element fixed to the actuator rod, causing the phase shift adjustment spindle drive gear to uncouple/couple, dependent on the direction of movement. Alternatively, the bearing support could only be tilted around the selector spindle so that a drive spindle supporting the phase shift adjustment spindle drive gear is lifted/lowered.

The sliding member may be a sliding pin and the corresponding sliding member may be a sliding pin guide, or vice versa. The sliding pin guide may be integrally formed in the actuating rod. Hence, the movement function selector element can easily be translated into the uncoupling/coupling movement of the phase shift adjustment spindle drive gear.

The phase shift adjustment gearing may include a drive spindle. The drive spindle supports the phase shift adjustment spindle drive gear. Particularly, the phase shift adjustment spindle drive gear is rotationally fixed to the drive spindle and linearly movable relative to the drive spindle by means of the phase shift spindle selector element. Further, the drive spindle may be supported by the at least one bearing support supporting the selector spindle. The bearing support may include further a bearing seat and a bearing (e.g. a plain bearing or a rolling bearing) for rotatingly support the drive spindle.

The drive spindle may support a drive spindle gear being rotationally fixed to the drive spindle. In this aspect, the coupling element may include a phase shift adjustment motor gear, being rotationally fixed to the coupling element. The drive spindle gear engages the phase shift adjustment motor gear when the function selector element is in its second position. Thus, the rotary driving actuator can drive the drive spindle and accordingly the phase shift adjustment spindle drive gear for driving a selected phase shift adjustment spindle to adjust a phase shift.

Further, the gearbox may be configured so that an angular position of the drive spindle gear is not changed, when the phase shift adjustment motor gear is engaged and/or re-engaged with the drive spindle gear, i.e. when the function selector element is in its second position (again).

The gearbox may further include an additional bearing support for the coupling element. Said additional bearing support includes a first receiving portion for receiving the drive spindle, allowing the drive spindle to be rotated relative to the bearing support and a second receiving portion for receiving the coupling element so as to allow the coupling element being rotated and translated relative to the bearing support. The first and second receiving portions may include a bearing seat and a bearing (e.g. a plain bearing and/or a rolling bearing) for supporting the coupling element. This allows for a compact design.

Each one of the at least two (at least three, at least five, at least seven) phase shift adjustment spindles may be coupled to a corresponding phase shift adjustment spindle drive gearing that is adapted to be coupled with the phase shift adjustment spindle drive gear, if the phase shift adjustment spindle is selected.

The corresponding phase shift adjustment spindle drive gearing may include a bevel gearing stage, and optionally a spur gear being rotationally fixed to a bevel gear of the bevel gearing stage. Further optionally, the phase shift adjustment spindle drive gear is also a spur toothed gear and adapted to be coupled with the spur gear of the corresponding phase shift adjustment spindle drive gearing, if the respective phase shift adjustment spindle is selected. Providing bevel gears allows to provide the phase shift adjustment spindles in an angle (preferably 90°) with respect to the drive spindle. Thus, installation of the gearbox at the antenna is facilitated. Further, the bevel gearing stage may be a self-locking gearing stage, thereby reducing drift of the gearing even further. Providing spur gears facilitates the coupling and allows to provide a further reduction stage to increase the accuracy of the phase shift adjustment.

The gearbox may further comprise at least one locking device, being assigned to a phase shift adjustment spindle. The locking device locks the phase shift adjustment spindle rotationally, if the phase shift adjustment spindle is not selected, and optionally if the phase shift adjustment spindle is selected but the function selector element is not in its second position. Thus, the risk of drifting can be reduced even further. Particularly, the gearbox may comprise multiple locking devices, each assigned to a respective one of the phase shift adjustment spindles.

The locking device may include a spring arm having a free end and a fixed end and being movable from a rest position to a loaded position. A locking element may be arranged on the spring arm, wherein the locking element is adapted to engage with the phase shift adjustment spindle and/or a gear of the corresponding phase shift adjustment spindle drive gearing so as to provide for the rotational locking of the phase shift adjustment spindle when being in the rest position. The locking element may protrude from the spring arm and may be adapted to engage with the teeth of the gear of the corresponding phase shift adjustment spindle drive gearing.

Further, the locking element may include or consist of a material which prevents the gear from rotating by a braking function. Particularly, the locking element may be coated with such a material (e.g. rubber, thermoplastic polyurethane, silicone, and/or the like).

The free end of the spring arm may be positioned so that it can be actuated via the coupling mechanism and moved in the loaded position, whereby the locking element is moved out of the rotational locking engagement to allow a rotation of the phase shift adjustment spindle. For example, the spring arm may be loaded, when the bearing support is lowered by the movement of the function selector element fixed to the actuator rod, and may return to the rest position when the bearing support is lifted again. In the rest position, the spring arm may be preloaded urging the locking element into locking engagement.

The gearbox may further include a control unit. The control unit may be adapted to remotely control the rotary driving actuator and the function selector actuator in order to adjust a radiation beam direction α, θ of an antenna. Optionally, the gearbox includes a memory, the memory comprising control parameters for controlling the rotary driving actuator and the function selector actuator. Hence, certain phase shift settings can be repetitively controlled.

The control parameters may include at least one of the following:
positions of the phase shift adjustment spindles,
an angular position of the drive spindle gear,
and/or an angular position of the phase shift adjustment motor gear.

In particular, the memory may have stored thereon respective positions of the phase shift adjustment spindles, so that the phase shift spindle selector element and respectively the phase shift adjustment spindle drive gear can be moved easily to the selected phase shift adjustment spindle to be driven.

Further, the control unit and in particular the memory thereof may store the angular position of the drive spindle gear and/or the phase shift adjustment motor gear, at the moment when the engagement of the phase shift adjustment motor gear and the drive spindle gear is out coupled, i.e. when the selector element is moved out of the second position. Thus, prior to re-engaging the phase shift adjustment motor gear and the drive spindle gear, the phase shift adjustment motor gear can be rotated in an angular position that allows engaging both gears, without changing the angular position of the drive spindle gear.

It is to be understood, that the angular position of the drive spindle gear and/or the phase shift adjustment motor gear can either be stored in absolute terms, or with a certain granularity. The granularity may be according to the number of teeth of the phase shift adjustment motor gear. Hence, prior to re-engaging the gears, the angular position of the teeth is the same as it was before the out coupling.

The gearbox may be mainly made out of an electrically non-conductive material, such as plastics. Particularly, the function selector spindle, the function selector element, the coupling mechanism, the actuator rod(s), the bearing support(s), the sliding pin(s), the phase shift spindle selector gearing, the phase shift spindle selector element, the selector spindle, the selector spindle coupling, the phase shift adjustment gearing, the phase shift adjustment spindle drive gear, the drive spindle, the drive spindle gear, the locking device, the spring arm, the locking element, the phase shift adjustment spindle(s), the bevel gearing, the bearing support for the coupling element, the coupling element, the phase shift adjustment motor gear and/or the corresponding selector spindle coupling may be made of an electrically non-conductive material, such as plastics. This allows to avoid undesired passive intermodulation between undefined electrically conductive (e.g. metallic) contacts. In case electrically conductive, particularly metallic parts are used, as e.g. in the actuator(s)/motor(s), a shielding may be provided. Further, electrically conductive/metallic parts can be arranged isolated.

The object is further achieved by an antenna, particularly a base station antenna, the antenna including at least two phase shifters for electrically adjusting a radiation beam direction of the antenna and multiple antenna elements. The antenna elements being arranged in multiple arrays (linear arrays and/or two-dimensional arrays), wherein a first array of the multiple arrays is assigned to a first phase shifter and a second array is assigned to a second phase shifter. At least the first and second phase shifters are adapted to be coupled with a respective phase shift adjustment spindle of a gearbox. The gearbox may be configured as described above. Particularly, the antenna may include the gearbox wherein at least the first and second phase shifters are coupled to a respective phase shift adjustment spindle of the gearbox.

The phase shifters of the antenna are adapted to adjust a tilt angle θ of a radiation beam 16 (i.e. vertical direction) of the antenna and/or an azimuth angle α of the radiation beam (i.e. horizontal direction) of the antenna. Optionally, the adjustment of the tilt angle θ and/or azimuth angle α is remotely controllable.

The object is further achieved by a base station, particularly a mobile communication base station, having at least one antenna as outlined above.

### BRIEF DESCRIPTION OF ACCOMPANYING FIGURES

Further features and advantages will be apparent from the following description as well as the accompanying drawings, to which reference is made. The drawings show in detail:

FIG. 1 schematically shows a mobile communication base station according to the invention;

FIG. 2 schematically shows an antenna, according to the invention;

FIG. 3A schematically shows a side view of a gearbox according to the invention;

FIG. 3B schematically shows a top view of the gearbox of FIG. 3A;

FIG. 4A schematically shows an isometric top view of the gearbox of FIG. 3A;

FIG. 4B schematically shows an isometric bottom view of the gearbox of FIG. 3A, and

FIG. 5 schematically shows some details of a locking device to be used in a gearbox.

### DETAILED DESCRIPTION OF ACCOMPANYING FIGURES

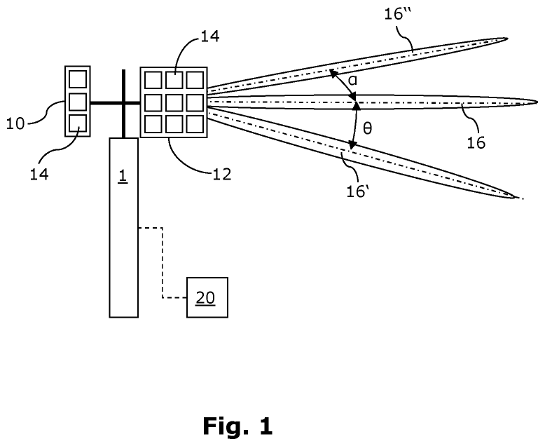

FIG. 1 schematically shows a mobile communication base station 1. The base station 1 may be a mobile communication base station, having at least one antenna 10, 12. The antennas 10, 12 each include at least two phase shifters and multiple antenna elements 14, wherein the antenna elements 14 are arranged in multiple arrays. The antennas are powered by a transmitter and/or transceiver 20. The feed current for each antenna element/array of antenna elements passes through one of the phase shifters controlled by a control unit.

The antennas 10, 12 may be multiband antennas, i.e. antennas emitting at least two different frequencies. A band is understood as a resonance frequency range, preferably defined as a continuous range with return loss of better than 10 dB and preferably better than 15 dB. Two different bands are understood as two different frequency ranges. For example, the antenna 10, 12 may be configured to be used for electromagnetic radiation having frequencies between 0.5 GHz and 5 GHz, in particular between 0.5 GHz and 3.5 GHz.

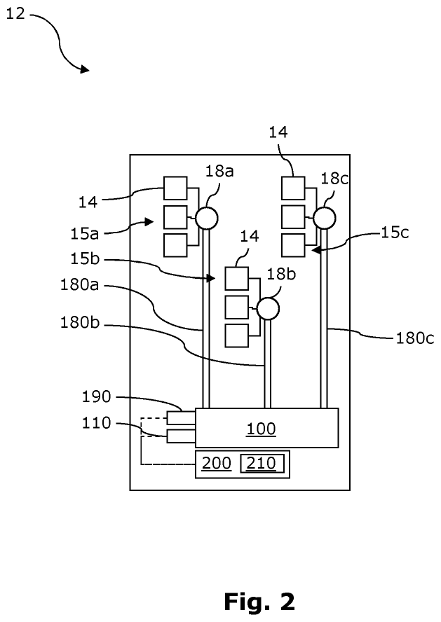

FIG. 2 shows an antenna 12 very schematically. The antenna 12 is for example a mobile communication antenna used in mobile communication base stations 1 (cf. FIG. 1).

The antenna 10 comprises a plurality of antenna elements 14, which may form arrays 15a, 15b, 15c, a plurality of phase shifters 18a, 18b, 18c and a gearbox 100. Further a control unit 200 and optionally a memory 210 may be provided.

The phase shifters 18a, 18b, 18c will control the distribution of the phase of the antenna elements 14 in the different arrays 15a, 15b, 15c. The different arrays 15a, 15b, 15c of the same antenna 12 may be dual polarized arrays, which operate in different frequency bands. The memory 210 may be part of the control unit 200 or separate from the control unit 200. In the shown example, the antenna 12 comprises three phase shifters.

The antenna elements 14 are for example radio frequency radiators, in particular dual polarized radiators. Each one of the phase shifters 15a, 15b, 15c is associated with one antenna element 14, meaning that the output ports of the phase shifter 15a, 15b, 15c are connected to the corresponding input ports of the associated antenna element 14.

The phase shifters 15a, 15b, 15c are for example differential phase shifters 15a, 15b, 15c as known in the art, for example from U.S. Pat. No. 6,850,130 B1. Of course, the phase shifters 15a, 15b, 15c may be of any other kind, for example dielectric phase shifters. The phase shifters 15a, 15b, 15c are driven separately, each by a separate phase shift adjustment spindle 180a, 180b, 180c of gearbox 100.

The control unit 200 controls the gearbox 100 via a rotary driving actuator 190 and a function selector actuator 110, as described in greater detail below, in order to actuate the phase shifters 18a, 18b, 18c.

By actuating the phase shifters 18a, 18b, 18c, the phase shift of the antenna elements 14 can be adjusted and accordingly, wave fronts of the radio waves emitted by each element 14. The individual wave fronts are combined (superimposed) in front of the antenna 10, 12 to create a plane wave, a radiation beam 16, 16′, 16″ travelling in a specific direction (cf. FIG. 1).

For tilting the radiation beam 16 downward, the phase shifters 18a, 18b, 18c delay the radio waves progressively in vertical direction so each antenna element 14 emits its wave front later than the one below it. This causes the resulting plane wave to be down-tilted by angle θ. For upward-tilting, the lower antenna elements 14 emit first. By changing the phase shifts, the control unit 200 can instantly adjust the angle θ of the radiation beam 16, 16′. An array may be a linear array (cf. antenna 10) or a two-dimensional array of antenna elements (cf. antenna 12). A linear array allows adjusting the radiation direction in one dimension (e.g. tilt angle θ or azimuth angle α, depending on the orientation of the linear array). A two-dimensional array allows adjusting the radiation beam in two dimensions (tilt angle θ and azimuth angle α), resulting in an adjusted radiation beam 16′, 16″.

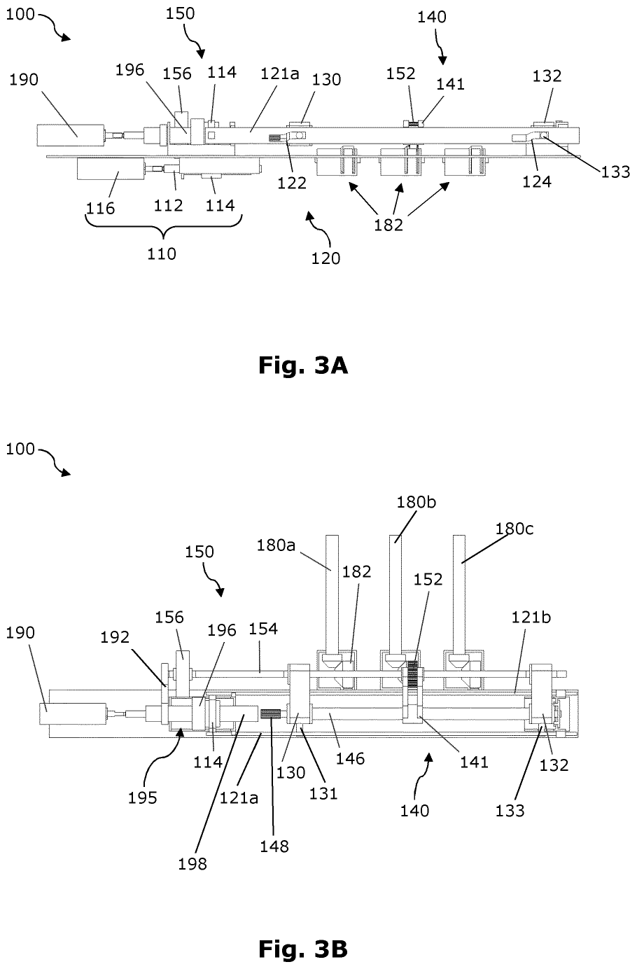

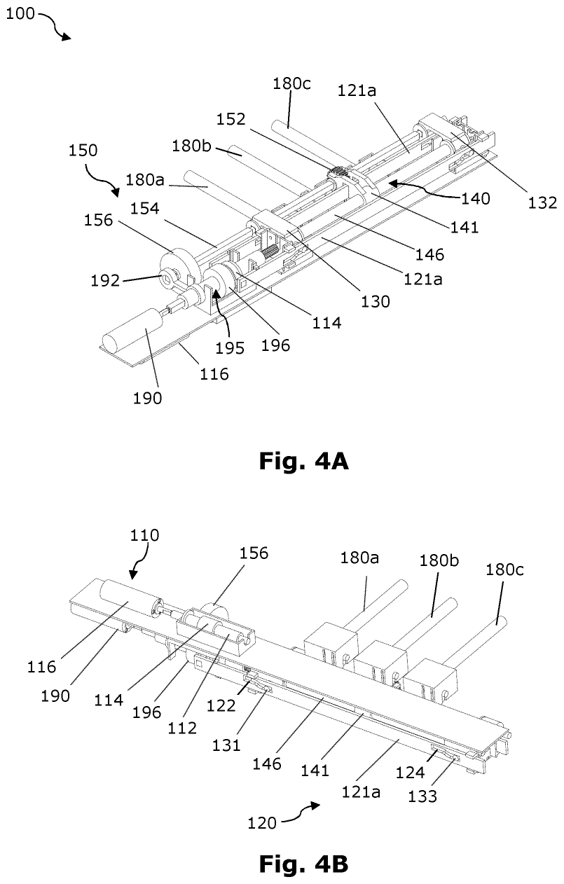

FIGS. 3A to 4B schematically show a gearbox 100 for an antenna 10, 12, particularly for a base station antenna. FIG. 3A schematically shows a side view of a gearbox 100, FIG. 3B a top view of the gearbox 100 FIG. 4A an isometric top view of the gearbox 100 and FIG. 4B an isometric bottom view of the gearbox 100.

The gearbox 100 comprises at least two (in the embodiment of FIGS. 3A to 4B) three phase shift adjustment spindles 180a, 180b, 180c. The phase shift adjustment spindles 180a, 180b, 180c are each coupled to a respective phase shifter 18a, 18b, 18c of an antenna and can be driven for electrically adjusting a radiation beam direction of the antenna.

It is to be understood, that the number of phase shifters and accordingly the number of phase shift adjustment spindles may vary. For example, an antenna may include at least three phase shifters, preferably at least five phase shifters, even more preferably at least seven phase shifters and most preferred at least nine phase shifters. Further, an antenna may include one or more gearboxes. For example, a first gearbox may be used for tilt angle adjustment and a second gearbox for azimuth angle adjustment.

Further, the gearbox comprises a rotary driving actuator 190, and a function selector actuator 110. The rotary driving actuator 190 may be an electric motor. The function selector actuator 110 includes a function selector motor 116, particularly a stepper motor, a function selector element 114 and a function selector spindle 112, particularly a threaded spindle. The function selector spindle can be driven by the function selector motor 116. The function selector element 114 is arranged linearly movable on the function selector spindle 112 and may include a threaded portion, so as to translate a rotational movement of the function selector motor 116 into a linear movement of the function selector element 114.

Further, the function selector element 114 is fixed to a coupling element 195 of the gearbox as well as to a coupling mechanism 120 and can be linearly moved from a first position to a second position thereby actuating the coupling element 195 and the coupling mechanism 120. Said coupling element 195 can be rotated by the rotary driving actuator 190.

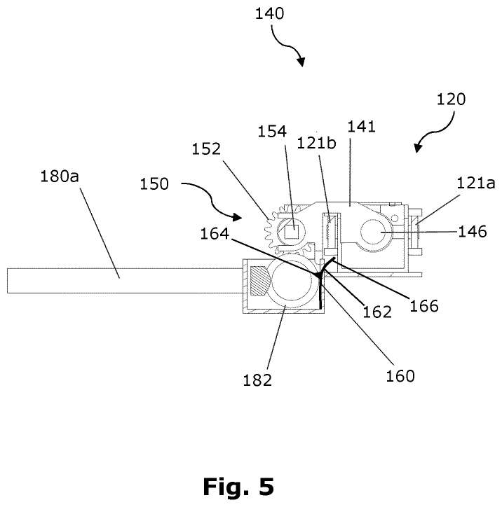

When the function selector element 114 is in its first position (as shown in FIG. 3A), the coupling element 195 is coupled with a phase shift spindle selector gearing 140. Said phase shift spindle selector gearing 140 translates a rotational movement of the rotary driving actuator 190 into a linear movement of a phase shift spindle selector element 141 in order to select a phase shift adjustment spindle 180a, 180b, 180c to be driven. The phase shift spindle selector element 141 supports a phase shift adjustment spindle drive gear 152 as best seen in FIG. 5. The phase shift adjustment spindle drive gear 152 is adapted to drive the selected phase shift adjustment spindle 180a, 180b, 180c via a bevel gearing 182. Hence, the rotary driving actuator 190 can drive the phase shift adjustment spindles 180a, 180b, 180c individually, allowing to adjust the respective phase shifters 18a, 18b, 18c individually, as well.

In the second position (not depicted), the coupling element 195 is coupled with a phase shift adjustment gearing 150 (and uncoupled from the phase shift spindle selector gearing 140). The phase shift adjustment gearing 150 couples the rotary driving actuator 190 with the phase shift adjustment spindle drive gear 152 in order to drive the selected phase shift adjustment spindle 180a, 180b, 180c. When the function selector element 114 is in its first position, the phase shift adjustment spindle drive gear 152 is uncoupled from the selected phase shift adjustment spindle 180a, 180b, 180c via the coupling mechanism 120 (cf. FIG. 5).

The function selector element 114 includes a bearing seat and a bearing for rotatingly support the coupling element 195. Hence, the coupling element 195 can be rotated relative to the function selector element 114, while a linear movement of the function selector element 114 causes a linear movement of the coupling element 195.

The phase shift spindle selector gearing 140 includes a selector spindle 146, particularly a screwed spindle. The selector spindle 146 has a selector spindle coupling 148 that is coupled with a corresponding selector spindle coupling 198 of the coupling element 195, when the function selector element 114 is in its first position and will be uncoupled, when the function selector element 114 is in its second position. The phase shift spindle selector element 141 engages with the selector spindle 146, so as to translate a rotational movement of the coupling element 195 provided by the rotary driving actuator 190 into a linear movement of the phase shift spindle selector element 141.

Hence, the phase shift spindle selector element 141 can travel along the selector spindle 146 and can be aligned with the phase shift adjustment spindles 180a, 180b, 180c to select a phase shift adjustment spindle 180a, 180b, 180c to be driven.

The selector spindle 146 is supported by two bearing supports 130, 132. The bearing supports 130, 132 each include a bearing for rotatingly support the selector spindle 146 and further a bearing for rotatingly support a drive spindle 154 of the phase shift adjustment gearing 150. Each bearing support 130, 132 includes two laterally protruding sliding pins 131, 133.

The coupling mechanism 120, as e.g. shown in FIG. 4B, includes two actuating rods 121a, 121b sandwiching the bearing supports 130, 132. It is to be understood, that the coupling mechanism 120 can be modified to include one actuating rod, only. Further, the coupling mechanism 120 may have multiple actuating rods.

The actuating rods 121a, 121b are directly fixed to the function selector element 114 such that a linear movement of the function selector element 114 actuates the actuating rods 121a, 121b linearly. Each actuating rod 121a, 121b includes two sliding pin guides 122, 124 that are engaged with the laterally protruding sliding pins 131, 133 of the bearing supports 130, 132. The sliding pin guides 122, 124 include a step, so that when the sliding pins 131, 133 pass the step (down to up), the bearing supports 130, 132 (and accordingly the selector spindle 146, the phase shift spindle selector element 141, the drive spindle 154 and the phase shift adjustment spindle drive gear 152) are lifted. Hence, the phase shift adjustment spindle drive gear 152 can be uncoupled from the selected phase shift adjustment spindle 180a, 180b, 180c. If the function selector element 114 is moved in the opposite direction, the sliding pins 131, 133 pass the step again (up to down) and are lowered. Thus, the phase shift adjustment spindle drive gear 152 can be coupled with the selected phase shift adjustment spindle 180a, 180b, 180c.

The phase shift adjustment gearing 150 includes the drive spindle 154 that is supported by the bearing supports 130, 132. Further, the drive spindle 154 supports the phase shift adjustment spindle drive gear 152 so that the phase shift adjustment spindle drive gear 152 is rotationally fixed to the drive spindle 154 and linearly movable relative to the drive spindle 154 by means of the phase shift spindle selector element 141.

The drive spindle 154 is attached to a. Said drive spindle gear 156 can be driven by a phase shift adjustment motor gear 198 of the coupling element 195. The drive spindle gear 156 can be engaged with the phase shift adjustment motor gear 198 by moving the function selector element 114 is in its second position. Thus, the rotary driving actuator 190 can drive the drive spindle 154 and accordingly the phase shift adjustment spindle drive gear 152. This allows driving a selected phase shift adjustment spindle 180a, 180b, 180c to adjust a phase shift.

The coupling element 195 is supported by an additional bearing support 192. Said additional bearing support 192 includes a first receiving portion for receiving the drive spindle 154, allowing the drive spindle 154 to be rotated relative to the bearing support 192 and a second receiving portion for receiving the coupling element 195 so as to allow the coupling element 195 being rotated and translated relative to the bearing support 192.

Each one of the at least two phase shift adjustment spindles 180a, 180b, 180c may be coupled to a corresponding phase shift adjustment spindle drive gearing (e.g. a bevel gearing 182) that is adapted to be coupled with the phase shift adjustment spindle drive gear 152, if the phase shift adjustment spindle 180a, 180b, 180c is selected.

FIG. 5 schematically shows some details of a locking device 160 to be e.g. used in the gearbox 100, described above. The locking device 160, is assigned to a phase shift adjustment spindle 180a. The locking device 160 is adapted to lock the phase shift adjustment spindle 180a rotationally, if required, i.e. if the phase shift adjustment spindle 180a is not selected, and optionally if the phase shift adjustment spindle 180a is selected but the function selector element 114 is not in its second position.

The locking device 160 shown in FIG. 5 includes a spring arm 162 having a free end (actuating end 166) and a fixed end. The fixed end is fixedly attached to a housing of the bevel gearing 182. The spring arm 162 can be reversely deflected from a rest position to a loaded position. A locking element 164 is arranged on the spring arm 162 and adapted to engage with bevel gearing 182 so as to provide for the rotational locking of the phase shift adjustment spindle 180a when being in the rest position. The free end 166 of the spring arm 162 is positioned so that it can be actuated via the coupling mechanism 120. In the embodiment shown in FIG. 5, the spring arm 162 is deflected (loaded), when the bearing supports 130, 132 and accordingly the phase shift spindle selector element 141 is lowered by the movement of the function selector element 114 fixed to the actuator rods 121a, 121b and returns to the rest position when the bearing supports 130, 132/phase shift spindle selector element 141 is lifted again. In particular, the free end 166 engages with the phase shift spindle selector element 141 and is deflected, when the phase shift spindle selector element is lowered.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

### LIST OF REFERENCE SIGNS

1 base station
10 base station antenna
12 base station antenna
14 antenna element
15 array
16 radiation beam
16′, 16″ adjusted radiation beam
18a, b, c phase shifter
20 transceiver
100 gearbox
110 function selector actuator
112 function selector spindle
114 function selector element
116 function selector motor
120 coupling mechanism
121a,b actuator rod
122 sliding pin guide
124 sliding pin guide
130 bearing support
131 sliding pin
132 bearing support
133 sliding pin
140 phase shift spindle selector gearing
141 phase shift spindle selector element
146 selector spindle
148 selector spindle coupling
150 phase shift adjustment gearing
152 phase shift adjustment spindle drive gear
154 drive spindle
156 drive spindle gear
160 locking device
162 spring arm
164 locking element
166 actuating end
180a, b, c phase shift adjustment spindle
182 bevel gearing
190 rotary driving actuator
192 bearing support for coupling element
195 coupling element
196 phase shift adjustment motor gear
198 corresponding selector spindle coupling
α azimuth angle (horizontal beam adjustment)
θ tilt angle (vertical beam adjustment)

1. A gearbox for an antenna, particularly for a base station antenna, the antenna including at least two phase shifters, the gearbox comprising:
at least two phase shift adjustment spindles that can be coupled to a respective phase shifter of the antenna and driven for electrically adjusting a radiation beam direction of the antenna;
a rotary driving actuator; and
a function selector actuator:
wherein:
the rotary driving actuator is adapted to rotate a coupling element of the gearbox;
the function selector actuator includes a movable function selector element that is fixed to the coupling element and to a coupling mechanism of the gearbox, wherein the function selector element is movable from a first position to a second position thereby actuating the coupling element and the coupling mechanism;
in the first position, the coupling element is coupled with a phase shift spindle selector gearing that translates the rotational movement of the rotary driving actuator into a linear movement of a phase shift spindle selector element in order to select a phase shift adjustment spindle to be driven, the phase shift spindle selector element supporting a phase shift adjustment spindle drive gear, that is adapted to drive the selected phase shift adjustment spindle;
in the second position, the coupling element is coupled with a phase shift adjustment gearing that couples the rotary driving actuator with the phase shift adjustment spindle drive gear to drive the selected phase shift adjustment spindle;
in the first position, the phase shift adjustment spindle drive gear is uncoupled from the selected phase shift adjustment spindle via the coupling mechanism; and
in the second position, the phase shift adjustment spindle drive gear is coupled with the selected phase shift adjustment spindle via the coupling mechanism.

2. The gearbox according to claim 1, wherein the function selector actuator further comprises:
a function selector motor, particularly a stepper motor; and
a function selector spindle, particularly a threaded spindle;
wherein the function selector element engages with the function selector spindle, so as to translate a rotational movement of the function selector motor into a linear movement of the function selector element.

3. The gearbox according to claim 1, wherein the function selector element further comprises a receiving portion for receiving the coupling element so as to allow the coupling element being rotated relative to the function selector element, while a linear movement of the function selector element causes a linear movement of the coupling element.

4. The gearbox according to claim 1, wherein the phase shift spindle selector gearing further comprises:
a selector spindle, particularly a screwed spindle, having a selector spindle coupling that is coupled with a corresponding selector spindle coupling of the coupling element, when the function selector element is in its first position;
wherein the phase shift spindle selector element engages with the selector spindle, so as to translate a rotational movement of the coupling element provided by the rotary driving actuator into a linear movement of the phase shift spindle selector element.

5. The gearbox according to claim 4, wherein:
the selector spindle is supported by at least one bearing support, the bearing support having a sliding member; and
the coupling mechanism includes at least on actuating rod, the actuating rod being fixed to the function selector element and including at least one corresponding sliding member, the sliding member being in engagement with the corresponding sliding member, wherein the corresponding sliding member is formed so that:
a movement of the function selector element from the first position to the second position moves the at least one bearing support causing the phase shift adjustment spindle drive gear to couple with the selected phase shift adjustment spindle; and
a movement from the second to the first position moves the at least one bearing support causing the phase shift adjustment spindle drive gear to uncouple from the selected phase shift adjustment spindle.

6. The gearbox according to claim 5, wherein the sliding member is a sliding pin, and wherein the corresponding sliding member is a sliding pin guide, the sliding pin guide being integrally formed in the actuating rod.

7. The gearbox according to claim 1, wherein the phase shift adjustment gearing further comprises;
a drive spindle, the drive spindle supporting the phase shift adjustment spindle drive gear, wherein the phase shift adjustment spindle drive gear is rotationally fixed to the drive spindle and linearly movable relative to the drive spindle by means of the phase shift spindle selector element.

8. The gearbox according to claim 5, wherein:
the drive spindle is supported by the at least one bearing support supporting the selector spindle.

9. The gearbox according to claim 7, wherein;
the drive spindle supports a drive spindle gear being rotationally fixed to the drive spindle and wherein the coupling element includes a phase shift adjustment motor gear, being rotationally fixed to the coupling element, wherein the drive spindle gear engages the phase shift adjustment motor gear when the function selector element is in its second position.

10. The gearbox according to claim 9, wherein:
the gearbox is configured so that an angular position of the drive spindle gear is not changed, when the phase shift adjustment motor gear is engaged and/or re-engaged with the drive spindle gear.

11. The gearbox according to claim 7, the gearbox further comprising;
a bearing support for the coupling element, the bearing support including:
a first receiving portion for receiving the drive spindle, allowing the drive spindle to be rotated relative to the bearing support; and
a second receiving portion for receiving the coupling element so as to allow the coupling element being rotated and translated relative to the bearing support.

12. The gearbox according to claim 1, wherein:
each one of the at least two phase shift adjustment spindles is coupled to a corresponding phase shift adjustment spindle drive gearing that is adapted to be coupled with the phase shift adjustment spindle drive gear, if the phase shift adjustment spindle is selected.

13. The gearbox according to claim 12, wherein:
the corresponding phase shift adjustment spindle drive gearing includes a bevel gearing stage.

14. The gearbox according to claim 1, further comprising at least one locking device being assigned to a phase shift adjustment spindle the locking device locking the phase shift adjustment spindle rotationally if:
the phase shift adjustment spindle is not selected.

15. The gearbox according to claim 14, further comprising multiple locking devices, each assigned to a respective one of the phase shift adjustment spindles.

16. The gearbox according to claim 14, wherein:
the locking device includes a spring arm having a free end and a fixed end and being movable from a rest position to a loaded position:
a locking element is arranged on the spring arm, the locking element being adapted to engage with the phase shift adjustment spindle and/or a gear of the corresponding phase shift adjustment spindle drive gearing so as to provide for the rotational locking of the phase shift adjustment spindle when being in the rest position; and
the free end of the spring arm can be actuated via the coupling mechanism so as to be moved in the loaded position, whereby the locking element is moved out of the rotational locking engagement to allow a rotation of the phase shift adjustment spindle.

17. The gearbox according to claim 1, further comprising:
a control unit, the control unit being adapted to remotely control the rotary driving actuator and the function selector actuator in order to adjust a radiation beam direction of an antenna; and
a memory, the memory comprising control parameters for controlling the rotary driving actuator and the function selector actuator, wherein the control parameters may include at least one of
positions of the phase shift adjustment spindles,
an angular position of the drive spindle gear, and/or
an angular position of the phase shift adjustment motor gear.

18. An antenna, in particular a base station antenna, the antenna including:
at least two phase shifters for electrically adjusting a radiation beam direction of the antenna; and
multiple antenna elements, the antenna elements being arranged in multiple arrays, wherein a first array of the multiple arrays is assigned to a first phase shifter and a second array is assigned to a second phase shifter;
wherein at least the first and second phase shifters are adapted to be coupled with a respective phase shift adjustment spindle of a gearbox, wherein the gearbox is configured according to claim 1.

19. The antenna according to claim 18, further including:
a gearbox for the antenna, the gearbox comprising:
at least two phase shift adjustment spindles that can be coupled to a respective phase shifter of the antenna and driven for electrically adjusting a radiation beam direction of the antenna;
a rotary driving actuator; and
a function selector actuator;
wherein:
the rotary driving actuator is adapted to rotate a coupling element of the gearbox;
the function selector actuator includes a movable function selector element that is fixed to the coupling element and to a coupling mechanism of the gearbox, wherein the function selector element is movable from a first position to a second position thereby actuating the coupling element and the coupling mechanism;
in the first position, the coupling element is coupled with a phase shift spindle selector gearing that translates the rotational movement of the rotary driving actuator into a linear movement of a phase shift spindle selector element in order to select a phase shift adjustment spindle to be driven, the phase shift spindle selector element supporting a phase shift adjustment spindle drive gear, that is adapted to drive the selected phase shift adjustment spindle;
in the second position, the coupling element is coupled with a phase shift adjustment gearing that couples the rotary driving actuator with the phase shift adjustment spindle drive gear to drive the selected phase shift adjustment spindle;
in the first position, the phase shift adjustment spindle drive gear is uncoupled from the selected phase shift adjustment spindle via the coupling mechanism; and
in the second position, the phase shift adjustment spindle drive gear is coupled with the selected phase shift adjustment spindle via the coupling mechanism;
wherein at least the first and second phase shifters are coupled to a respective phase shift adjustment spindle the gearbox.

20. The antenna according to claim 18, wherein:
the phase shifters of the antenna are adapted to adjust a tilt angle of a radiation beam of the antenna and/or an azimuth angle of the radiation beam of the antenna; and
the adjustment of the tilt angle and/or azimuth angle is optionally remotely controllable.

21. (canceled)
